(19) United States
(12) Patent Application Publication
(10) Pub. No.: US 2022/0027907 A1
(43) Pub. Date: Jan. 27, 2022

(54) SECURE PROCESS TO AVOID STORING PAYMENT CREDENTIALS

(71) Applicant: BANK OF AMERICA CORPORATION, CHARLOTTE, NC (US)

(72) Inventors: Vijay Kumar Yarabolu, Hyderabad (IN); Ravi Prasad Challagulla, Secunderabad (IN); Durga Prasad Patro, Hyderabad (IN)

(21) Appl. No.: 16/934,245

(22) Filed: Jul. 21, 2020

(51) Int. Cl. G06Q 20/40; G06Q 20/38

(52) U.S. Cl. CPC G06Q 20/401; G06Q 20/409; G06Q 20/38215

(57) ABSTRACT

A credential security tool may avoid storing payment credentials at online services. Generally, the credential security tool issues authorization tokens to merchants when users attempt to store payment credentials with the merchants. The merchants store these authorization tokens rather than the payment credentials. When a user initiates a transaction with a merchant, the merchant can present the authorization token to receive a masked card that can be used to complete the transaction. When the merchant presents the masked card for payment, the credential security tool can use the actual card information to complete the transaction.

### TECHNICAL FIELD

This disclosure relates generally to securing online transactions, and in particular, by avoiding the storage of a user's payment credentials.

### BACKGROUND

Many online services are available for users to make online purchases. For the convenience of the user, the online services conventionally offer the option to store the users' payment credentials. When the credentials are stored, the user is provided a more convenient experience during subsequent purchases because the user may avoid re-entering the credentials.

### SUMMARY OF THE DISCLOSURE

Many online services are available for users to make online purchases. To use these services, users typically create an account with the service and make purchases using the account. During payment, users are often given the option to store payment credentials for the convenience of the user. For example, the user may store information such as a name, billing address, payment card number, payment card expiration date, security code, etc. By storing this information, the user may use these credentials to conduct future transactions without having to re-enter the information. Storing payment credentials, however, introduces a host of security issues. For example, the credentials may be taken by a malicious user who manages to break into the online service. As another example, the online service may unintentionally leak the payment credentials to a malicious user. Additionally, storing payment credentials may also be inconvenient for the user. For example, payment credentials (e.g., card numbers, expiration dates, etc.) change periodically. When those changes occur, the user is forced to change the payment credentials at each online service where the credentials are stored.

This disclosure contemplates a credential security tool that avoids storing payment credentials at online services in certain embodiments. Generally, the credential security tool issues authorization tokens to merchants when users attempt to store payment credentials with the merchants. The merchants store these authorization tokens rather than the payment credentials. When a user initiates a transaction with a merchant, the merchant can present the authorization token to receive a masked card that can be used to complete the transaction. When the merchant presents the masked card for payment, the credential security tool can use the actual card information to complete the transaction. In this manner, the merchant is not given the actual card information for use or storage, which improves the security of the actual card information in certain embodiments. Additionally, because the merchant does not store the payment credentials, the user does not update the payment credentials at the merchant when the payment credentials change. Certain embodiments are described below.

According to an embodiment, an apparatus includes a memory and a hardware processor communicatively coupled to the memory. The hardware processor receives, from a merchant, information about a user. The information about the user is communicated in response to the user attempting to store payment credentials with the merchant. The hardware processor identifies the user using the information about the user and, after identifying the user, communicates a widget to a device of the user. The hardware processor receives, through interaction with the widget, authentication information from the user, authenticates the user using the authentication information, and after authenticating the user, communicates an authorization token to the merchant, the merchant stores the authorization token rather than the payment credentials.

According to another embodiment, an apparatus includes a memory and a hardware processor communicatively coupled to the memory. The hardware processor receives, from a merchant, an authorization token. The merchant communicates the authorization token in response to a user initiating a transaction with the merchant. The merchant stores the authorization token rather than payment credentials of the user. The hardware processor, after receiving the authorization token from the merchant, communicates, to the merchant, information for a masked payment card of the user and after communicating the information for the masked payment card to the merchant, receives the information for the masked payment card and information for the transaction. The hardware processor also, in response to receiving the information for the masked payment card and the information for the transaction, validates that the information for the masked payment card is correct and in response to validating that the information for the masked payment card is correct, communicates information for an actual payment card of the user to complete the transaction.

Certain embodiments provide one or more technical advantages. For example, an embodiment improves the security of payment credentials by allowing the payment credentials to not be stored at a merchant. Certain embodiments may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure, reference is now made to the following description, taken in conjunction with the accompanying drawings, in which:

FIG. 1 illustrates an example system;

FIG. 2 illustrates an example credential security tool in the system of FIG. 1;

FIGS. 3A and 3B are flowcharts illustrating methods of securing credentials using the system of FIG. 1.

### DETAILED DESCRIPTION

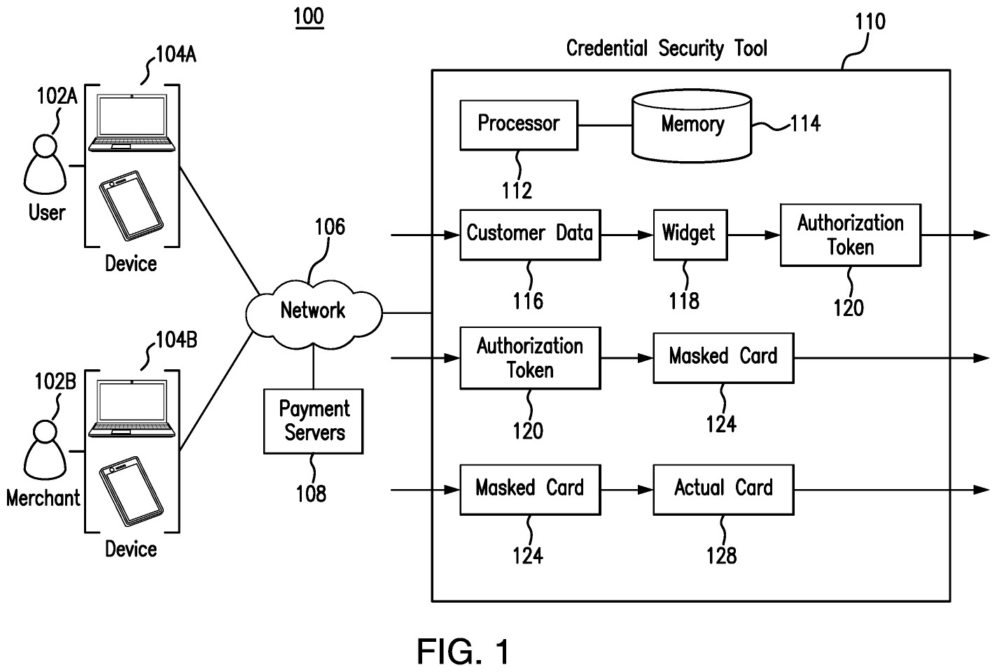

Embodiments of the present disclosure and its advantages are best understood by referring to FIGS. 1 through 3 of the drawings, like numerals being used for like and corresponding parts of the various drawings.

Many online services are available for users to make online purchases. To use these services, users typically create an account with the service and make purchases using the account. During payment, users are often given the option to store payment credentials for the convenience of the user. For example, the user may store information such as a name, billing address, payment card number, payment card expiration date, security code, etc. By storing this information, the user may use these credentials to conduct future transactions without having to re-enter the information. Storing payment credentials, however, introduces a host of security issues. For example, the credentials may be taken by a malicious user who manages to break into the online service. As another example, the online service may unintentionally leak the payment credentials to a malicious user. Additionally, storing payment credentials may also be inconvenient for the user. For example, payment credentials (e.g., card numbers, expiration dates, etc.) change periodically. When those changes occur, the user is forced to change the payment credentials at each online service where the credentials are stored.

This disclosure contemplates a credential security tool that avoids storing payment credentials at online services in certain embodiments. Generally, the credential security tool issues authorization tokens to merchants when users attempt to store payment credentials with the merchants. The merchants store these authorization tokens rather than the payment credentials. When a user initiates a transaction with a merchant, the merchant can present the authorization token to receive a masked card that can be used to complete the transaction. When the merchant presents the masked card for payment, the credential security tool can use the actual card information to complete the transaction. In this manner, the merchant is not given the actual card information for use or storage, which improves the security of the actual card information in certain embodiments. Additionally, because the merchant does not store the payment credentials, the user does not update the payment credentials at the merchant when the payment credentials change.

A practical application of the credential security tool is that the tool improves the security of payment credentials by storing an authorization token at a merchant rather than the payment credentials. This design makes it more difficult for a malicious user to access payment credentials at the merchant. The system will be described in more detail using FIGS. 1 through 3.

FIG. 1 illustrates an example system 100. As seen in FIG. 1, system 100 includes one or more devices 104, a network 106, one or more payment servers 108, and credential security tool 110. Generally, system 100 stores authorization tokens at merchants rather than payment credentials. In this manner, the security of the payment credentials are improved in certain embodiments.

User 102A and merchant 102B use devices 104A and 104B to interact with other components of system 100. For example, user 102A may use device 104A to initiate a transaction with merchant 102B and/or devices 104B. As another example, merchant 102B may use device 104B to process transactions with payment servers 108 and/or payment credential tool 110. In the example of FIG. 1, user 102A may use device 104A to initiate a transaction with merchant 102B and/or device 104B. User 102A may desire to store payment credentials with merchant 102B and/or device 104B to improve the convenience to 102A in the future. Rather than store the actual payment credentials of 102A with merchant 102B and/or device 104B, system 100 may perform a process by which an authorization token is stored with merchant 102B and/or device 104B. Merchant 102B or device 104B may present the authorization token to conduct future transactions. By storing the authorization token rather than the payment credentials of user 102A, the security of the payment credentials is improved in certain embodiments. For example, a malicious user may find it more difficult to access the payment credentials when the payment credentials are not stored with the merchant 102B and/or device 104B. As another example, merchant 102B and/or device 104B may not be able to leak the payment credentials to a malicious user if the payment credentials are not stored with the merchant 102B and or device 104B.

Devices 104 include any appropriate device for communicating with components of system 100 over network 106. For example, devices 104 may be a telephone, a mobile phone, a computer, a laptop, a tablet, an automated assistant, and/or a cash register. This disclosure contemplates device 104 being any appropriate device for sending and receiving communications over network 106. As an example and not by way of limitation, device 104 may be a computer, a laptop, a wireless or cellular telephone, an electronic notebook, a personal digital assistant, a tablet, or any other device capable of receiving, processing, storing, and/or communicating information with other components of system 100. Device 104 may also include a user interface, such as a display, a microphone, keypad, or other appropriate terminal equipment usable by user 102. Device 104 may include a hardware processor, memory, and/or circuitry configured to perform any of the functions or actions of device 104 described herein. For example, a software application designed using software code may be stored in the memory and executed by the processor to perform the functions of device 104.

Network 106 allows communication between and amongst the various components of system 100. For example, user/merchant 102 may use devices 104 to communicate over network 106. This disclosure contemplates network 106 being any suitable network operable to facilitate communication between the components of system 100. Network 106 may include any interconnecting system capable of transmitting audio, video, signals, data, messages, or any combination of the preceding. Network 106 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Payment servers 108 may include any number of devices (e.g., computers and/or servers) that process payments on behalf of merchant 102B or device 104B. For example, payment servers 108 may be presented with transaction details and payment credentials. In response, payment servers 108 may complete the transaction according to the transaction details and the payment credentials. Payment servers 108 may then issue a payment to merchant 102B or device 104B and charge a credit to user 104A or device 104A. In the example of FIG. 1, payment servers 108 may receive payment credentials from credential security tool 110 rather than merchant 102B and/or device 104B because payment credentials are not stored with merchant 102B or device 104B.

Credential security tool 110 handles the payment credentials of user 102A and/or device 104A. Generally, credential security tool 110 issues authorization tokens to merchant 102B and/or device 104B rather than the payment credentials of user 102A and/or device 104A. When the authorization token is presented to the credential security tool 110, credential security tool 110 issues a masked card to merchant 102B or device 104B. A masked card may then be used to complete the transaction. In this manner, the security of the payment credentials of user 102A and/or device 104A is improved in certain embodiments. In the example of FIG. 1, the credential security tool 110 includes a processor 112 and a memory 114. Processor 112 and memory 114 may be configured to perform any other the actions or functions of credential security tool 110 described herein.

Processor 112 is any electronic circuitry, including, but not limited to microprocessors, application specific integrated circuits (ASIC), application specific instruction set processor (ASIP), and/or state machines, that communicatively couples to memory 114 and controls the operation of credential security tool 110. Processor 112 may be 8-bit, 16-bit, 32-bit, 64-bit or of any other suitable architecture. Processor 112 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. Processor 112 may include other hardware that operates software to control and process information. Processor 112 executes software stored on memory to perform any of the functions described herein. Processor 112 controls the operation and administration of credential security tool 110 by processing information received from devices 104, network 106, and memory 114. Processor 112 may be a programmable logic device, a microcontroller, a microprocessor, any suitable processing device, or any suitable combination of the preceding. Processor 112 is not limited to a single processing device and may encompass multiple processing devices.

Memory 114 may store, either permanently or temporarily, data, operational software, or other information for processor 112. Memory 114 may include any one or a combination of volatile or non-volatile local or remote devices suitable for storing information. For example, memory 114 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in memory 114, a disk, a CD, or a flash drive. In particular embodiments, the software may include an application executable by processor 112 to perform one or more of the functions described herein.

Credential security tool 110 may perform an enrollment function and a payment function. During the enrollment function, credential security tool 110 generates an authorization token that can be stored at a merchant 102B. During the payment function, merchant 102B may present the authorization token to credential security tool 110 to initiate and/or complete a transaction.

To initiate the enrollment function, a user 102A may use the device 104A to attempt to store payment credentials with merchant 102B or device 104B. For example, the user may provide a name, an address, a birthday, etc. Additionally, the user 102A may provide payment credentials to be stored (e.g., a card number, an expiration date, a security code, etc.). User 102A may further select an issuer of the payment credentials. In certain embodiments, the user information, payment credentials, and/or selected issuer are communicated to merchant 102B or device 104B. Merchant 102B or device 104B then communicate the user information, payment credentials, and/or selected issuer to credential security tool 110. In other embodiments, the user information, payment credentials, and/or selected issuer are intercepted by credential security tool 110 before the user information, payment credentials, and/or selected issuer reach merchant 102B and/or device 104B.

Credentials security tool 110 receives customer data 116 (e.g., user information, payment credentials, and/or selected issuer) as discussed above.

Customer data 116 may include information about user 102A and or payment credentials of user 102A. In response to receiving customer data 116, credential security tool 110 identifies user 102A and/or device 104A based on customer data 116. Credential security tool 110 then communicates a widget 118 to device 104A. In some embodiments, device 104A may already contain or store widget 118. In these embodiments, credential security tool 110 activates widget 118 on device 104A. Widget 118 may provide an interface on 104A that requests certain interactions from user 102A. For example, widget 118 may ask user 102A if user 102A has requested the storage of customer data 116 with merchant 102B. User 102A may then interact with widget 118 to authorize or confirm the storage of payment credentials. If user 102A does not authorize or confirm the storage of the payment credentials, then credential security tool 110 may halt or stop the storage of customer data 116. If user 102A authorizes the storage of the payment credentials, then credential security tool 110 may continue with the enrollment process.

To continue with the enrollment process, credential security tool 110 generates an authorization token 120 which may include a key and/or encrypted information that identifies user 102A and/or payment credentials of user 102A. However, it may not be possible to derive the identity of 102A and/or the payment credentials of user 102A based on the authorization token 120 alone. In certain embodiments, authorization token 120 may adhere to a particular token standard (e.g., Open Authentication). Credential security tool 110 communicates authorization token 120 to merchant 102B or device 104B. Merchant 102B or device 104B may then store authorization token 120 for subsequent use. For example, the next time user 102A desires to conduct a transaction with merchant 102B using the payment credentials, merchant 102B may present the authorization token 120 to complete the transaction. In this manner, user 102A enjoys the convenience of having stored payment credentials without suffering the security concerns of storing payment credentials at merchant 102B or device 104B.

The payment function begins when a user 102A initiates a transaction. When user 102A attempts to initiate a transaction with the merchant 102B using the payment credentials, merchant 102B may communicate the authorization token 120 for user 102A to credential security tool 110. Credential security tool 110 receives authorization token 120 and in response, generates a masked card 124. Masked card 124 may include temporary payment credentials that can be used to conduct a transaction on behalf of user 102A. The temporary payment credentials in masked card 124 may be significantly different than the actual payment credentials of user 102A. In other words, even if masked card 124 were intercepted, it would not be possible to derive the actual payment credentials of user 102A from masked card 124. Credential security tool 110 communicates masked card 124 to merchant 102B and/or device 104B. Merchant 102B or device 104 B may then use masked card 124 to complete the transaction. In certain embodiments, masked card 124 is temporary and may be used only for the transaction requested by user 102A. As a result, masked card 124 is discarded after the transaction is complete. In this manner, even if masked card 124 were intercepted by a malicious user, the malicious user would not be able to use masked card 124 to conduct any transactions, which improves the security of the transaction.

Credential security tool 110 may receive masked card 124 after communicating masked card 124 to merchant 102B and/or device 104B. For example, credential security tool 110 may receive masked card 124 from payment servers 108. In certain embodiments, credential security tool 110 may also receive transaction details along with masked card 124. In response to receiving masked card 124, credential security tool 110 validates the information in masked card 124 to ensure that the information is correct. If the information is correct, credential security tool 110 will then retrieve an actual card 128 of user 102A. The actual card 128 includes the actual payment credentials for user 102A (e.g., a card number, expiration date, security code, etc.). Credential security tool 110 communicates actual card 128 along with transaction details to payment servers 108, thereby facilitating an exchange of masked card 124 for actual card 128. Payment servers 108 may then complete the transaction using actual card 128. In this manner, credential security tool 110 processes a transaction between user 102A and merchant 102B without merchant 102B ever accessing the actual payment credentials of user 102A. As a result, the security of the payment is improved in certain embodiments.

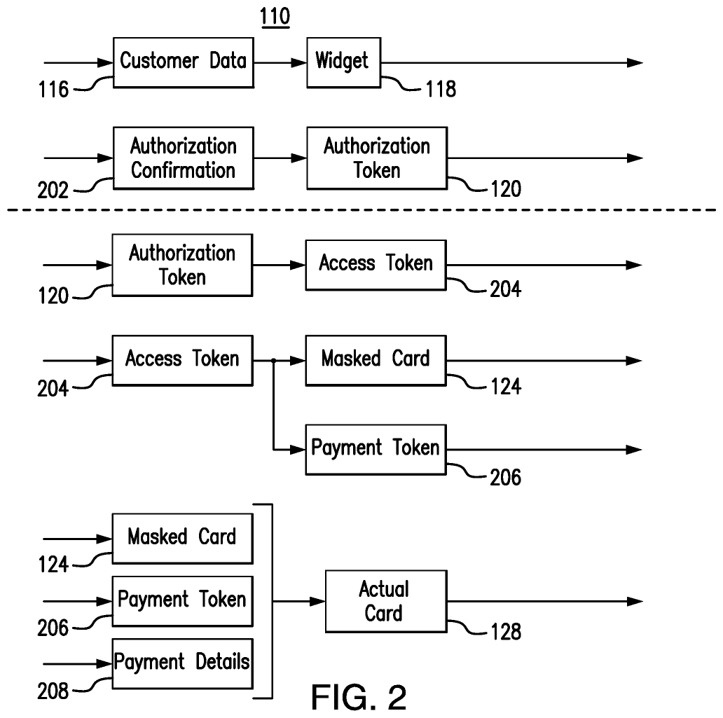

FIG. 2 illustrates an example credential security tool 110 in the system 100 of FIG. 1. Generally, credential security tool 110 performs an enrollment function and a payment function that improves the security of payment credentials in certain embodiments.

Credential security tool 110 begins the enrollment function by receiving customer data 116. Customer data 116 may include information that identifies a user 102A and information that would identify a particular payment credential such as, for example, a card name and/or issuer name. Credential security tool 110 may use customer data 116 to identify a user 102A and/or a particular payment credential of user 102A. Credential security tool 110 may then communicate a widget 118 to a device 104A of user 102A and/or activate a widget 118 in a device 104A of the user 102A. The user 102A may then interact with the widget 118 to authorize the storage of payment credentials. If authorization is given, credential security tool 110 may continue with the enrollment function. If authorization is not given, credential security tool 110 may halt the enrollment process.

Credential security tool 110 may receive an authentication confirmation 202. In certain embodiments, user 102A may provide authentication confirmation 202 by interacting with widget 118. Receipt of authentication confirmation 202 indicates that credential security tool 110 should proceed with the enrollment function. In response to receiving authentication confirmation 202, credential security tool 110 generates an authorization token 120. Authorization token 120 may include information that can be used to link authorization token 120 to user 102A and/or particular payment credentials of user 102A. However, it may not be possible to derive the identity of user 102A and/or the payment credentials of user 102A through authorization token 120 alone. Credential security tool 110 may communicate authorization token 120 to a merchant 102B or device 104B. Merchant 102B and/or device 104B may store authorization token 120 in lieu of the payment credentials of user 102A. Authorization token 120 may be subsequently used to conduct transactions involving the payment credentials of user 102A.

Credential security tool 110 may begin the payment function by receiving authorization token 120. Authorization token 120 may be communicated by a merchant 102B and/or device 104B. The merchant 102B and/or device 104B may have communicated authorization token 120 in response to a user 102A initiating a transaction with merchant 102B and indicating that stored payment credentials should be used. Merchant 102B and/or device 104B may communicate authorization token 120 to credential security tool 110 to initiate the transaction involving the payment credentials of user 102A even though merchant 102B and/or device 104B do not store the payment credentials of user 102A.

Credential security tool 110 generate an access token 204 in response to receiving authorization token 120 in certain embodiments. Access token 204 may be used to establish a session with merchant 102B and/or device 104B. Credential security tool 110 may communicate access token 204 to merchant 102B and/or device 104B to establish a session. Merchant 102B and/or device 104B may communicate access token 204 back to credential security tool 110 to establish the session. In certain embodiments, credential security tool 110 may validate the access token 204 received from merchant 102B and/or device 104B before establishing the session with merchant 102B and/or device 104B. In some embodiments, merchant 102B and/or device 104B may include a request for resources along with access token 204.

Credential security tool 110 may generate a masked card 124 in response to receiving authorization token 120 and/or access token 204. As discussed previously, masked card 124 may include fake credentials that are temporarily used for user 102A. Masked card 124 may be used only for the requested transaction in certain embodiments. In some embodiments, masked card 124 is discarded after the transaction with user 102A is complete so that masked card 124 is not used for any subsequent transactions. Credential security tool 110 communicates masked card 124 to merchant 102B and/or device 104B so that merchant 102B and/or device 104B may use masked card 124 to process the requested transaction. In particular embodiments, credential security tool 110 may also generate a payment token 206. Payment token 206 may include information concerning the transaction and masked card 124. Credential security tool 110 communicates payment token 206 to merchant 102B and/or device 104B along with masked card 124 in these embodiments.

Merchant 102B and/or device 104B may use masked card 124 and/or payment token 206 to complete the requested transaction. In certain embodiments, merchant 102B and/or device 104B may communicate masked card 124, payment token 206, and/or transaction details to payment servers 108. Payment servers 108 may then use this information to complete the transaction with credential security tool 110. For example, payment servers 108 may communicate masked card 124, payment token 206, and/or payment details 208 to credential security tool 110. When credential security tool 110 receives this information, credential security tool 110 may validate the information, specifically masked card 124 and payment token 206. If this information is valid, credential security tool 110 may then complete the transaction according to payment details 208. For example, credential security tool 110 may generate an actual card 128 that includes the actual payment credentials of user 102A. Credential security tool 110 then communicates actual card 128 to payment servers 108. Payment servers 108 may then use the payment credentials in actual card 128 to complete the transaction. For example, payment servers 108 may use the payment credentials to issue payment to merchant 102B and/or device 104B and to charge a credit to user 102A and/or device 104A. In this manner, the transaction is completed using the actual payment credentials of user 102A even though these payment credentials are not stored with merchant 102B and/or device 104B. As a result, the security of the payment credentials is improved while still providing user 102A with the convenience of stored payment credentials in certain embodiments.

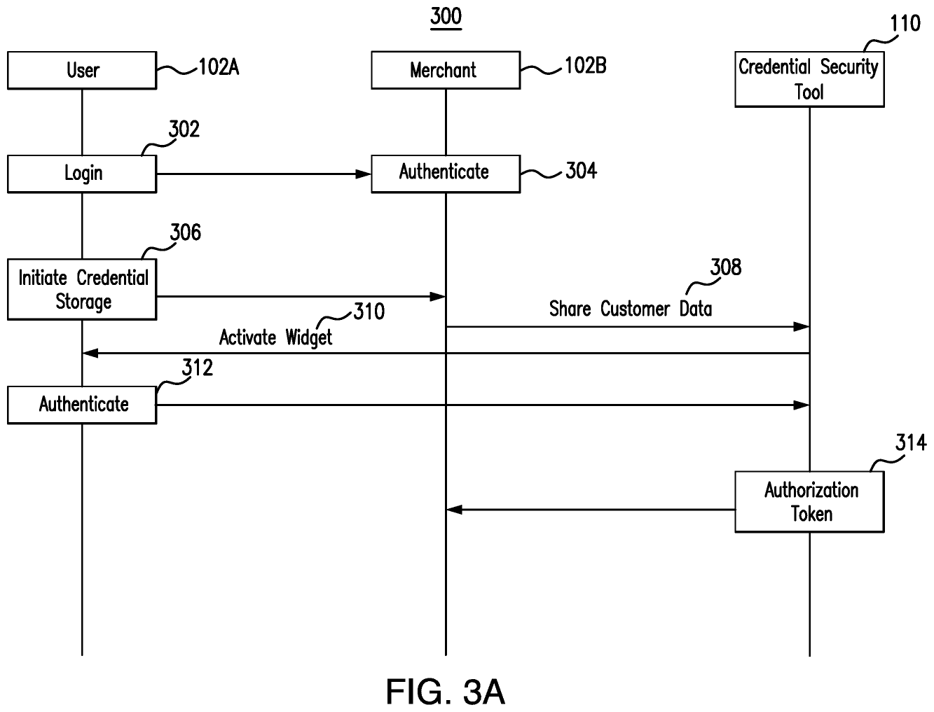

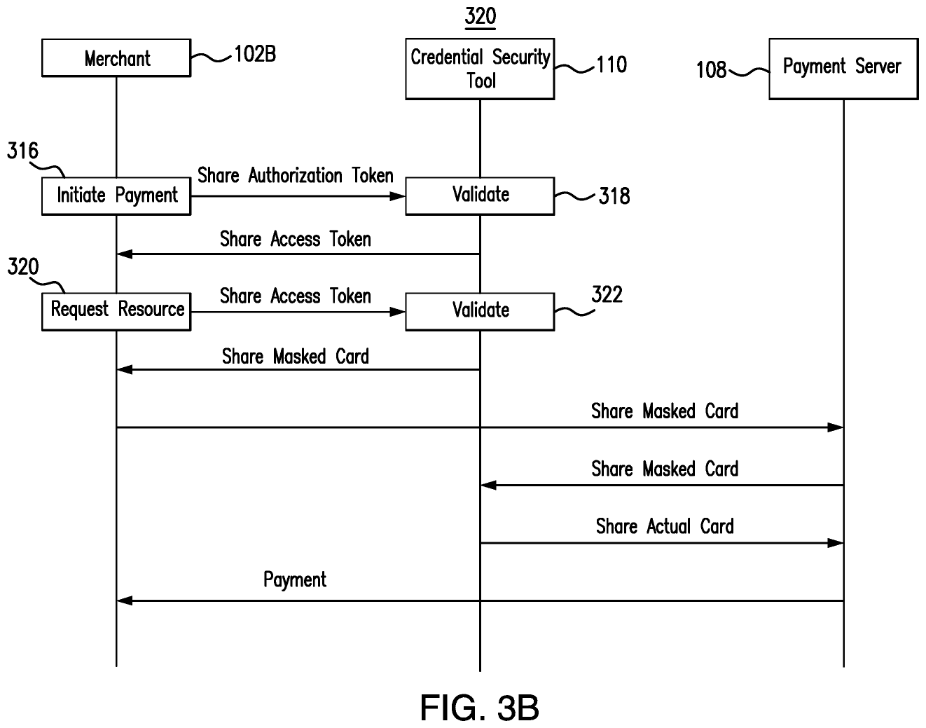

FIGS. 3A and 3B are flowcharts illustrating methods 300 and 320 of securing credentials using a system 100 of FIG. 1. Generally, various components of system 100 perform the steps of methods 300 and 320. FIG. 3A shows the enrollment function and FIG. 3B shows the payment function. In particular embodiments, by performing methods 300 and/or 320, the security of payment credentials is improved.

Method 300 begins with user 102A and/or device 104A performing a login in step 302. The login may be performed with merchant 102B and/or device 104B. In step 304, merchant 102B authenticates user 102A using the information provided during login. After the login is complete, user 102A initiates credential storage in step 306. User 102A may request that merchant 102B store payment credentials of user 102A so that merchant 102B may subsequently use that information to conduct transactions. In some embodiments, merchant 102B may communicate the payment credentials to credential security tool 110. In other embodiments, credential security tool 110 may intercept the payment credentials before they reach merchant 102B.

Merchant 102B may share customer data 116 with credential security tool 110 in step 308. In some embodiments, customer data 116 is intercepted by credential security tool 110. Customer data 116 may include information that identifies user 102A and/or the payment credentials of user 102A. Credential security tool 110 may use customer data 116 to perform the enrollment function so that merchant 102B does not store the payment credentials of user 102A. Credential security tool 110 activates a widget 118 in step 310. Credential security tool 110 may communicate the widget 118 to user 102A and/or activate the widget 118 on a device 104A of user 102A in step 310. User 102A may then interact with the widget 118 to perform an authorization and/or authentication in step 312. After performing the authentication and/or authorization, credential security tool 110 may receive an authentication confirmation 202. In response to receiving authentication confirmation 202, credential security tool 110 generates and communicates an authorization token 120 in step 314. Credential security tool 110 may communicate authorization token 120 to merchant 102B. Merchant 102B may then store the authorization token 120 rather than the payment credentials of user 102A.

FIG. 3B illustrates the payment function. The payment function begins with merchant 102B initiating a payment in step 316. A user 102A may have requested a particular transaction with merchant 102B using seemingly stored payment credentials. In response, merchant 102B shares authorization token 120 with credential security tool 110. Credential security tool 110 validates the authorization token 120 in step 318. If the authorization token 120 is not valid, credential security tool 110 may reject the transaction. If the authorization token 120 is valid, credential security tool 110 may continue with the payment function and share access token 204 with merchant 102B. Merchant 102B may receive the access token 204 and request a resource in step 320. To request a resource, merchant 102B may share the access token 204 with credential security tool 110. In response to receiving access token 204 from merchant 102B, credential security tool 110 may validate access token 204 in step 322. If access token 204 is not valid, credential security tool 110 may stop the payment function. If access token 204 is valid, credential security tool 110 may establish a session with merchant 102B.

Credential security tool 110 may then share a masked card 124 with merchant 102B. After receiving masked card 124, merchant 102B may communicate or share masked card 124 with payment servers 108. After payment server 108 receives masked card 124, payment server 108 may present masked card 124 to credential security tool 110. In response to receiving masked card 124, credential security tool 110 may share actual card 128 with payment server 108. Payment server 108 may then use actual card 128 to complete the transaction. For example, payment server 108 may issue a payment to merchant 102B using the payment credentials in actual card 128.

Modifications, additions, or omissions may be made to methods 300 and 320 depicted in FIG. 3. Methods 300 and 320 may include more, fewer, or other steps. For example, steps may be performed in parallel or in any suitable order. While discussed as particular components of system 100 performing the steps, any suitable component of system 100 may perform one or more steps of the methods.

Although the present disclosure includes several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. An apparatus comprising:
a memory; and
a hardware processor communicatively coupled to the memory, the hardware processor configured to:
receive, from a merchant, an authorization token, the merchant communicating the authorization token in response to a user initiating a transaction with the merchant, the merchant stores the authorization token rather than payment credentials of the user;
after receiving the authorization token from the merchant, communicate, to the merchant, information for a masked payment card of the user;
after communicating the information for the masked payment card to the merchant, receive the information for the masked payment card and information for the transaction;
in response to receiving the information for the masked payment card and the information for the transaction, validate that the information for the masked payment card is correct; and
in response to validating that the information for the masked payment card is correct, communicate information for an actual payment card of the user to complete the transaction.

2. The apparatus of claim 1, wherein the information for the masked payment card is discarded after the transaction is completed.

3. The apparatus of claim 1, the hardware processor is further configured to:
communicate an access token to the merchant after receiving the authorization token from the merchant; and
receive the access token from the merchant before communicating the information for the masked payment card to the merchant.

4. The apparatus of claim 1, wherein the information for the actual payment card is not communicated to the merchant.

5. The apparatus of claim 1, the hardware processor further configured to validate the authorization token before communicating the information for the masked payment card to the merchant.

6. The apparatus of claim 1, the hardware processor further configured to:
communicate a widget to a device of the user;
receive, through interaction with the widget, authentication information from the user;
authenticate the user using the authentication information; and
after authenticating the user and before receiving the authorization token from the merchant, communicate the authorization token to the merchant.

7. The apparatus of claim 1, the hardware processor further configured to communicate a payment token to the merchant along with the information for the masked payment card.

8. A method comprising:
receiving, by a hardware processor communicatively coupled to a memory and from a merchant, an authorization token, the merchant communicating the authorization token in response to a user initiating a transaction with the merchant, the merchant stores the authorization token rather than payment credentials of the user;
after receiving the authorization token from the merchant, communicating, by the hardware processor and to the merchant, information for a masked payment card of the user;
after communicating the information for the masked payment card to the merchant, receiving, by the hardware processor, the information for the masked payment card and information for the transaction;
in response to receiving the information for the masked payment card and the information for the transaction, validating, by the hardware processor, that the information for the masked payment card is correct; and
in response to validating that the information for the masked payment card is correct, communicating, by the hardware processor, information for an actual payment card of the user to complete the transaction.

9. The method of claim 8, wherein the information for the masked payment card is discarded after the transaction is completed.

10. The method of claim 8, further comprising:
communicating, by the hardware processor, an access token to the merchant after receiving the authorization token from the merchant; and
receiving, by the hardware processor, the access token from the merchant before communicating the information for the masked payment card to the merchant.

11. The method of claim 8, wherein the information for the actual payment card is not communicated to the merchant.

12. The method of claim 8, further comprising validating, by the hardware processor, the authorization token before communicating the information for the masked payment card to the merchant.

13. The method of claim 8, further comprising:
communicating, by the hardware processor, a widget to a device of the user;
receiving, by the hardware processor and through interaction with the widget, authentication information from the user;
authenticating, by the hardware processor, the user using the authentication information; and
after authenticating the user and before receiving the authorization token from the merchant, communicating, by the hardware processor, the authorization token to the merchant.

14. The method of claim 8, further comprising communicating, by the hardware processor, a payment token to the merchant along with the information for the masked payment card.

15. A system comprising:
a merchant device; and
a credential security tool comprising a memory and a hardware processor communicatively coupled to the memory, the hardware processor configured to:
receive, from the merchant device, an authorization token, the merchant device communicating the authorization token in response to a user initiating a transaction with the merchant device, the merchant device stores the authorization token rather than payment credentials of the user;
after receiving the authorization token from the merchant device, communicate, to the merchant device, information for a masked payment card of the user;
after communicating the information for the masked payment card to the merchant device, receive the information for the masked payment card and information for the transaction;
in response to receiving the information for the masked payment card and the information for the transaction, validate that the information for the masked payment card is correct; and
in response to validating that the information for the masked payment card is correct, communicate information for an actual payment card of the user to complete the transaction.

16. The system of claim 15, wherein the information for the masked payment card is discarded after the transaction is completed.

17. The system of claim 15, the hardware processor is further configured to:
communicate an access token to the merchant device after receiving the authorization token from the merchant; and
receive the access token from the merchant device before communicating the information for the masked payment card to the merchant device.

18. The system of claim 15, wherein the information for the actual payment card is not communicated to the merchant device.

19. The system of claim 15, the hardware processor further configured to validate the authorization token before communicating the information for the masked payment card to the merchant device.

20. The system of claim 15, the hardware processor further configured to:
communicate a widget to a device of the user;
receive, through interaction with the widget, authentication information from the user;
authenticate the user using the authentication information; and
after authenticating the user and before receiving the authorization token from the merchant device, communicate the authorization token to the merchant device.
